(19) United States
(12) Patent Application Publication
(10) Pub. No.: US 2009/0120375 A1
(43) Pub. Date: May 14, 2009

(54) Retractable leash safety strap

(76) Inventor: Deric Dyer, Medford, MA (US)

Correspondence Address: THOMAS P. GRODT ATTORNEY AT LAW, 4 PEABOY ROAD ANNEX, DERRY, NH, 03038, US

(21) Appl. No.: 11/939,152

(22) Filed: Nov. 13, 2007

(51) Int. Cl. A01K 29/00

(52) U.S. Cl. 119/769

(57) ABSTRACT

A safety strap for use with a retractable leash is described in which a wrist engagement and a leash engagement portion are longitudinally oriented with respect to one another and connected via a connection member. The wrist engagement portion is configured to fit around the wrist of a user and the lease engagement portion encircles the handle of the retractable leash itself. The longitudinal orientation of the two portions ensures that the handle of the retractable leash is oriented such that it can be grasped by the user.

### BACKGROUND

The present invention relates generally to the field of dog leashes and in particular to a safety strap used for retractable leashes.

Retractable leashes have become increasingly popular due to their ability to allow the leash to extend and provide the dog with increased range, but also for their ability to “reel in” the dog when the dog's owner desires the dog to be closer to them. The typical retractable leash includes a plastic handle having a grip that must be continuously grasped with a hand. Thus, if an owner needs to use two hands to pick something up, for example while scooping poops, an owner walking their dog with a retractable leash must let go of the retractable leash to use both their hands to accomplish the desired task. This poses a risk as the dog may take this opportunity to attempt to run away or lunge at an animal and be able to escape taking the retractable leash with them.

The prior art has not fully attempted to address these problems, and therefore what is needed in the art is a safety strap suitable for use with a retractable leash that allows the owner to release their grip on the retractable leash but not relinquish control over the animal.

### SUMMARY

A safety strap for use with a retractable leash is described in which a wrist engagement and a leash engagement portion are longitudinally oriented with respect to one another and connected via a connection member. The wrist engagement portion is configured to fit around the wrist of a user and the lease engagement portion encircles the handle of the retractable leash itself. The longitudinal orientation of the two portions ensures that the handle of the retractable leash is oriented such that it can be grasped by the user.

A safety strap for a retractable leash is disclosed that includes a wrist engagement member that is sized and configured to form a wrist encircling loop, a leash engagement that is member sized and configured to form a retractable leash handle encircling loop, and the wrist engagement member and the lease engagement member are longitudinally oriented with respect to one another and connected to one another via a connection member. In one embodiment, the wrist engagement member includes first and second wrist strap members each having first ends, and a fastener having first and second cooperating members, the first member being connected to the first end of the first wrist strap member and the second member being connected to the first end of the second wrist strap member. The fastener may be a side release buckle or a loop through which the other end is disposed through that includes hook and loop fasteners. The wrist engagement member may also include a loop adjustment member operative to adjust the circumference of the wrist encircling loop whereby said wrist encircling loop is adjusted to fit about a user's wrist.

The first and second wrist strap members also have a second end, wherein each second end is connected to the connection member via a first and a second loop and wherein the connection member includes a first ring being disposed within said first loop and wherein the second end of the second wrist strap member includes a second loop and wherein the connection member includes a second ring being disposed within said second loop and wherein said leash engagement member is disposed within said first and second rings. The first and second rings may be D-rings and may be constructed from metal or plastic.

The leash engagement member may also include first and second leash strap members each having first ends and a fastener having first and second cooperating members, the first member being connected to the first end of the first leash strap member and the second member being connected to the first end of the second leash strap member surface. The fastener may be a side release buckle or a loop through which the other end is disposed through that includes hook and loop fasteners. The leash engagement member may also include a loop adjustment member operative to adjust the circumference of the retractable leash encircling loop whereby said retractable leash encircling loop is adjusted to a desired size.

### BRIEF DESCRIPTION OF THE DRAWINGS

These and other features, aspects, and advantages of the present invention will become better understood with regard to the following description, appended claims, and accompanying drawings. The drawings are not necessarily to scale, emphasis instead being placed on illustration of principles of the invention. The drawings include the following figures:

FIG. 1 is a perspective view of the safety strap; and

FIG. 2 is a perspective view of the present invention in use.

### DETAILED DESCRIPTION OF THE DRAWINGS

The present invention may be understood by the following detailed description, which should be read in conjunction with the attached drawings. The following detailed description of certain embodiments is by way of example only and is not meant to limit the scope of the present invention.

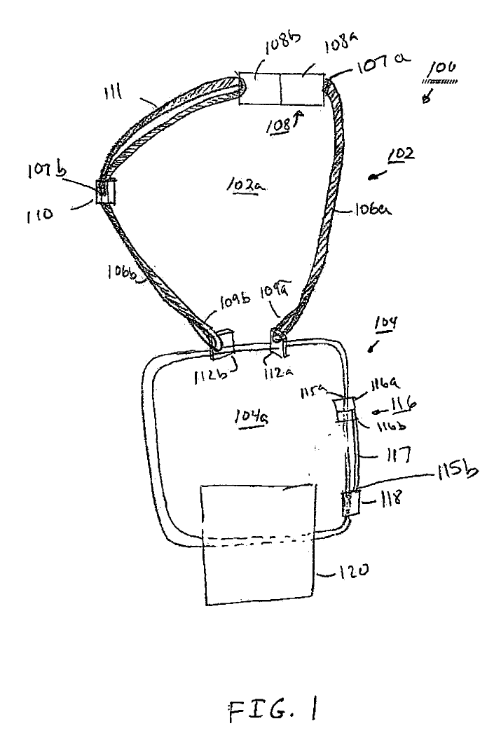

FIG. 1 depicts an embodiment of the presently described safety strap. In particular, the safety strap 100 includes a wrist engaging portion 102 forming a wrist encircling loop 102a and a retractable leash engaging portion 104 forming a leash encircling loop 104a, connected by loops 112a and 112b.

The wrist engagement portion 102 is comprised of a first wrist strap member 106a, which is attached at a first end 107a to fastener 108 at a first fastener end 108a and a second strap member 106b that passes through slide adjustment 110, is looped through the second fastener end 108b, and is attached to slide adjustment 110 at the second end 107b of the second wrist strap member 106b. This forms loop 111 between the fastener 108 and slide adjustment 110. The first and second wrist strap members 106a and 106b also have second ends 109a and 109b that are attached to loops 112a and 112b respectively. The loop adjustment mechanism 110 is operable to adjust the size of the wrist encirclement loop 102a via adjustment of the size of loop 111. In one embodiment, the loop adjustment mechanism 110 is a slide loop adjustment that allows for the adjustment of the wrist encirclement loop 102a via loop 111. In another embodiment, the loop adjustment mechanism is a ladder lock adjustment buckle.

In the depicted embodiment, the loops 112a and 112b are attached to second ends 109a and 109b of first and second wrist straps members 106a and 106b, respectively, via a loop formed in the first and second ends 109a and 109b. The loop may be formed using the wrist strap material itself looped back upon and affixed to itself using thread, staples, hook and loop fasteners, glue, or any other suitable fastening method.

In this embodiment, the loops 112a and 112b are not fixed in place, but rather are able to “float” and thereby adjust the distance between the two loops 112a and 112b in response to varying positions and loads placed on the safety strap by the retractable leash and/or the dog.

In another embodiment, the wrist engagement portion 102 may be comprised a single piece wrist strap member with an open end having ends 107a and 107b attached to opposite sides of fastener 108 at ends 108a and 108b, respectively. In this embodiment, the wrist strap member passes through loops 112a and 112b.

The retractable leash engaging portion 104 is comprised of a single piece of material with an open end having first and second ends 115a and 115b, respectively. The first end 115a is attached to side 116a of fastener 116 and the second end 115b passes through slide adjustment 118, is looped through the fastener end 116b, and is attached to slide adjustment 118 forming loop 117 between the fastener 116 and slide adjustment 118. The loop adjustment member 118 is operable to adjust the size of the retractable leash encirclement loop 104a. In one embodiment, the loop adjustment member 118 is a slide loop adjustment that allows for the adjustment of the retractable leash encirclement loop 104a via loop 117. In another embodiment, the loop adjustment mechanism is a ladder lock adjustment buckle, which would require that retractable leash engaging portion 104 be split into two pieces with the two pieces of material engaging the ladder lock adjustment buckle as is known in the art. In another embodiment, there is no loop adjustment member 118 and the end 107b is attached to end 108b of fastener 108, which may have a slide adjustment capability as is known in the art.

The leash engaging portion 104 is configured to fit through the interior portion of loops 112a and 112b. The leash engaging portion 104 may include a loop adjustment mechanism 118 that is operable to adjust the size of the leash encirclement loop 104a. In this embodiment, the loop adjustment mechanism 118 is a slide adjustment and the The diameter of the leash engagement loop should be sufficient to allow the leash encirclement loop 104a to encircle the handle portion of a retractable leash 120. In another embodiment, the loop adjustment member 118 is a ladder lock adjustment buckle. In another embodiment, there is no loop adjustment member 118 and the end 107b is attached to end 108b of fastener 108, which may have a slide adjustment capability as is known in the art.

The wrist engagement portion 102a and the leash engagement portion 104a are aligned longitudinally such that the diameters of the wrist portion 102 are parallel with corresponding diameters of the leash portion 104 and such that the wrist portion 102 and the leash portion 104 together form an extended FIG. 8. It is important that the wrist engagement portion 102 and the leash engagement portion 104 are longitudinally aligned as described above and are not transverse to one another. When longitudinally aligned with one another, the handle of the retractable leash 120 is properly oriented to be grasped by the user. Were the wrist portion 102 and leash engagement portion 104 to be transverse to one another, the handle portion 120 of the retractable leash would not be properly oriented to be grasped by the user.

In one embodiment, the first and second cooperative fasteners 108a and 108b can be rigid fasteners, which are typically made of plastic, and that have cooperating structures that can be inserted one into the other and that become releasably attached to one another. The fastener 108 is then configured as described above. In this embodiment, the fastener 108 may be a side release buckle.

The fastener 108 may also be any other form of suitable fastener. For example, the first and second cooperating fasteners 108a and 108b of fastener 108 may be a loop attachment that has a first end that is affixed to first end 107a and that has a second end that includes a loop portion. The second end 107b is dimensioned to be threaded through the loop portion. After being threaded throught the loop portion, cooperating hook and loop fasteners suitably placed on the first end 107b can then be threaded through the loop element and releasably fasten to one another thus forming wrist encircling loop 102a.

The fastener 116 may be any suitable fastener. In one embodiment, the first and second cooperative fasteners 116a and 116b can be rigid fasteners, which are typically made of plastic, and that have cooperating structures that can be inserted one into the other and that become releasably attached to one another. First and second ends 115a and 115b are attached to first and second cooperative fasteners 116a and 116b, respectively forming wrist encircling loop 104a. In this embodiment, the fastener 116 may be a side release buckle.

The fastener 116 may also be any other form of suitable fastener. For example, the first and second cooperating fasteners 116a and 116b of fastener 116 may be a loop attachment that has a first end that is affixed to first end 115a and that has a second end that includes a loop portion. The second end 115b is dimensioned to be threaded through the loop portion. After being threaded throught the loop portion, cooperating hook and loop fasteners suitably placed on the first end 115b can then be threaded through the loop element and releasably fasten to one another thus forming wrist encircling loop 104a.

The loops 112a and 112b may be metal or plastic and be any suitable shape. In a preferred embodiment, the loops 112a and 112b are D-rings and are metal.

In one embodiment, the wrist strap member 106a can be constructed from woven fabric flat cord ⅜-½ inches wide and 11 inches long. Wrist strap member 106b can be constructed from woven fabric flat cord ⅜-½ inches wide and 4 inches long. The leash engagement portion 104 can be constructed from woven fabric flat cord ⅜-½ inches wide and 8½ inches long. In the event that the slide adjustment member 116, then leash engagement member 104 can be constructed from woven fabric flat cord ⅜-½ inches wide and 6½ inches long.

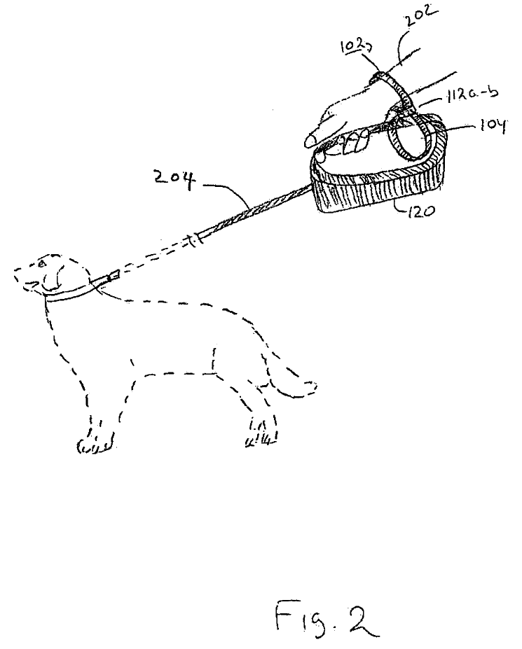

FIG. 2 depicts the safety strap in use. The user places their wrist 202 through the wrist engagement portion 102a and grasps the handle portion of the retractable leash 120. The retractable leash 120 provides a leash 204 that extends to the dog's collar to restrain the dog.

While the present invention has been particularly shown and described with references to preferred embodiments thereof, it will be understood by those skilled in the art that various changes in form and details may be made therein without departing from the spirit and scope of the invention as defined by the appended claims. All the features disclosed in this specification, including any accompanying claims, abstract, and drawings, may be replaced by alternative features serving the same, equivalent or similar purpose, unless expressly stated otherwise.

1. A safety strap for a retractable leash having a handle comprising:
a wrist engagement member sized and configured to form a wrist encircling loop;
a leash engagement member sized and configured to form a retractable leash handle encircling loop; and
a connection member operative to couple the wrist engagement member to the leash engagement member; and
wherein the wrist engagement member and the lease engagement member being longitudinally oriented with respect to one another forming an elongated FIG. 8.

2. The safety strap of claim 1 wherein, the wrist engagement member includes:
first and second wrist strap members each having first ends; and
a fastener having first and second cooperating members, the first member being connected to the first end of the first wrist strap member and the second member being connected to the first end of the second wrist strap member.

3. The safety strap of claim 2 wherein the fastener is a side release buckle.

4. The safety strap of claim 2 wherein the fastener includes a loop attached to said first end of said first wrist strap member and wherein said first end of said second wrist strap member is disposed through said loop and wherein said first end of said second wrist strap member includes portions having hook and loop fasteners such that when disposed through said loop said portions of said first end of said second wrist strap member having hook and loop fasteners may releasably connect with one another.

5. The safety strap of claim 2 wherein, the first and second wrist strap members each have a second end, wherein each second end is connected to said connection member.

6. The safety strap of claim 5, wherein the second end of the first wrist strap member includes a first loop and wherein the connection member includes a first ring being affixed within said first loop and wherein the second end of the second wrist strap member includes a second loop and wherein the connection member includes a second ring being affixed within said second loop and wherein said leash engagement member is disposed within said first and second rings.

7. The safety strap of claim 6 wherein said first and second rings are D-rings.

8. The safety strap of claim 6 wherein said first and second rings are metal.

9. The safety strap of claim 6 wherein said first and second rings plastic.

10. The safety strap of claim 1, wherein, the leash engagement member includes:
first and second leash strap members each having first ends; and
a fastener having first and second cooperating members, the first member being connected to the first end of the first leash strap member and the second member being connected to the first end of the second leash strap member surface.

11. The safety strap of claim 10 wherein the fastener is a side release buckle.

12. The safety strap of claim 11 wherein the fastener includes a loop attached to said first end of said first wrist strap member and wherein said first end of said second wrist strap member is disposed through said loop and wherein said first end of said second wrist strap member includes portions having hook and loop fasteners such that when disposed through said loop said portions of said first end of said second wrist strap member having hook and loop fasteners may releasably connect with one another.

13. The safety strap of claim 1 wherein said wrist engagement member further includes a loop adjustment member operative to adjust the circumference of the wrist encircling loop whereby said wrist encircling loop is adjusted to fit about a user's wrist.

14. The safety strap of claim 2 wherein said wrist engagement member further includes a loop adjustment member operative to adjust the circumference of the wrist encircling loop whereby said wrist encircling loop is adjusted to fit about a user's wrist, said loop adjustment member configured to allow said wrist engagement portion to pass therethrough, said first end of said wrist engagement portion being looped through said fastener and affixed to said loop adjustment member.

15. The safety strap of claim 1 wherein said leash engagement member further includes a loop adjustment member operative to adjust the circumference of the retractable leash encircling loop whereby said retractable leash encircling loop is adjusted to a desired size.

16. The safety strap of claim 10 wherein said leash engagement member further includes a loop adjustment member operative to adjust the circumference of the leash encircling loop whereby said leash encircling loop is adjusted to fit about the handle of the retractable leash of said wrist, said loop adjustment member configured to allow said leash engagement portion to pass therethrough, said first end of said wrist engagement portion being looped through said fastener and affixed to said loop adjustment member.
